(19) United States
(12) Patent Application Publication
(10) Pub. No.: US 2015/0240428 A1
(43) Pub. Date: Aug. 27, 2015

(54) METHOD AND DEVICE FOR FORCE-DEPENDENT CONTROLLING IN THE MACHINING OF RAILS

(71) Applicant: VOSSLOH MFL RAIL MILLING GMBH, Liezen (AT)

(72) Inventors: Erich Hartl, Laakirchen (AT); Wolfgang Neuhold, Gmunden (AT); Gerhart Liedl, Admont (AT)

(21) Appl. No.: 14/426,516

(22) PCT Filed: Aug. 30, 2013
(86) PCT No.: PCT/AT2013/000141

§ 371 Date: Mar. 6, 2015

(30) Foreign Application Priority Data
Sep. 13, 2012 (AT) A 998/2012

(51) Int. Cl. E01B 31/12; B23Q 15/12; B23Q 17/09; B23Q 15/013

(52) U.S. Cl. CPC E01B 31/12; B23Q 15/013; B23Q 15/12; B23Q 17/0966

(57) ABSTRACT

Method and device for controlling at least one pressing device (20) and at least one machining tool which are mounted on a rail vehicle and which are used for the machining of a laid rail (10), at least the forces at at least one pressing device (20) and/or the forces at at least one machining device being measured and used as control variables for the rail machining process.

The invention relates to a method and a device by means of force-dependent control of at least one contact pressure device and/or at least one machining tool for machining rails on laid rails. Such a method and device are described in claim 1 and dependent claims 2-5, the device in claim 6 and further dependent claims 7-13.

Machining rails for laid railway or underground railway rails or streetcar rails is fundamentally known, as mentioned, for example, in patent EP 0952255 A1. In general, the goals are defined in the case of all rail machining so that maximum removal of the flaws or cracks is to be achieved, depending on the rail state, simultaneously with the least possible material removal, and also with the best possible surface quality or dimensional accuracy with respect to the longitudinal and/or transverse profile. Grinding applications are encountered in this case more in the field of the lesser removal performance, and milling is encountered more in the field of the greater feed depths. Furthermore, planing applications are known for reprofiling rails.

The requirements with respect to the machining accuracy and surface quality are becoming greater and greater in particular under the aspect of low noise generation of the traveling train as a result of the rolling noise, which is to be minimized. These represent expanded and novel demands for the machining methods, particularly in regard to the rail tracking of the machining tools, to achieve the above-mentioned requirements.

Exact and solid track contact cannot always be presumed as the starting position in practice. Although in this case maintaining the track by filling would be expedient, nonetheless, such track sections or subsections are also to be produced with a satisfactory machining result because of the deficient timeframe.

In addition, differing subsoil conditions are generally also to be expected in certain route sections. These are above all the region of shunts, intersections, or also bridges.

Furthermore, the rail materials used and the heat treatments of the rails are not always known or these can also vary in sections. This in turn indicates different machining conditions with respect to different machining ability of the rails.

Multiple proposed solutions are known in the prior art for stabilizing the rails and for applying the machining tools, which can be divided into two subgroups in principle.

On the one hand, contact pressure devices as rollers or adjustable sliding elements—also referred to as contact shoes or sliding shoes—are used, which track or adjust the machining tools in height in a force-guided manner, wherein an independent feed movement of the machining tools can also still be represented. In this case, patents DE 3222208 A1 or EP 0952255 A1 are examples in the prior art.

An adjustment is performed via mechanical systems such as spindle drives, eccentrics, etc. or via hydraulic or pneumatic cylinders with or without pressure controller. If a pressure controller is provided, defined and settable pressures are used both on the rod side and also on the piston side in a pre-tensioned cylinder. Such hydraulic cylinders are also known as HNC units.

However, it has been shown in operation of such systems that, due to external loads during the machining of rails, for example, cutting forces, increased forces occur in the guides and transverse forces occur in the cylinder, which substantially increases the friction forces and therefore the system must be redefined.

However, this is not measurable for the hydraulic control, since the friction forces arise between the hydraulic cylinder and the contact pressure device. Therefore, it is not known with which force the contact pressure device is pressed against the rail and since this is not measurable, it is therefore also no longer exactly settable or controllable.

In addition to these friction forces due to tension of the system, above all in the event of small movements both in the guides and also the cylinder, there are stick-slip effects, which have the result that in total the contact forces, which are specified by the controller in the hydraulic cylinder, deviate from the reality on the railhead.

In the event of poor rail contact, as can occur due to insufficiently filled subsoil, but also due to earth movements, water, or other environmental influences, the occurrence of oscillations is to be expected due to constant contact pressure with a force which is not adapted, which negatively influences the machining result and therefore must be avoided.

Such oscillations can also occur in less solid track sections, however, for example, on bridges, or at intersections or shunts.

Since heretofore no items of information have been known about the actually existing forces at the contact pressure device and/or in the machining tool, the force is set rather higher, to ensure a certain contact pressure. This has a disadvantageous effect on the power consumption due to the high forces and above all on the wear of all components, but in particular on the contact pressure elements, and also the rail and the machining tools. Therefore, managing with the least possible forces is desirable.

Due to the complexity of the systems and the unknown substructures, and also the changing rail qualities, operator-controlled machining is necessary. The operator must keep the overall machining system as stable as possible by manual intervention in the system, usually according to experiential values.

The object of the present invention is therefore to solve the described disadvantages of the existing systems and the problems linked thereto in the machining of rails and to provide a device and a method which ensures an optimum contact pressure device by way of a regulated controller on the basis of recorded contact forces and/or cutting forces. In this case, the force measurement is to be performed as close as possible to the actual contact point or machining point, to avoid the discussed friction forces and interfering influences as much as possible and be able to operate with low forces.

The method according to the invention and the device according to the invention will be described hereafter on the basis of several examples and are characterized by claim 1 and the following claims and claim 6 and the following claims.

In the method according to the invention, a contact pressure device having a force measuring unit as close as possible to the interface of contact pressure device to rail and/or a machining tool having a further force measuring unit as close as possible to the interface of machining tool to rail is proposed. As close as possible means a distance of at most 150 mm.

This can be applied in multiple embodiment variants. The invention will be described in greater detail on the basis of several variants.

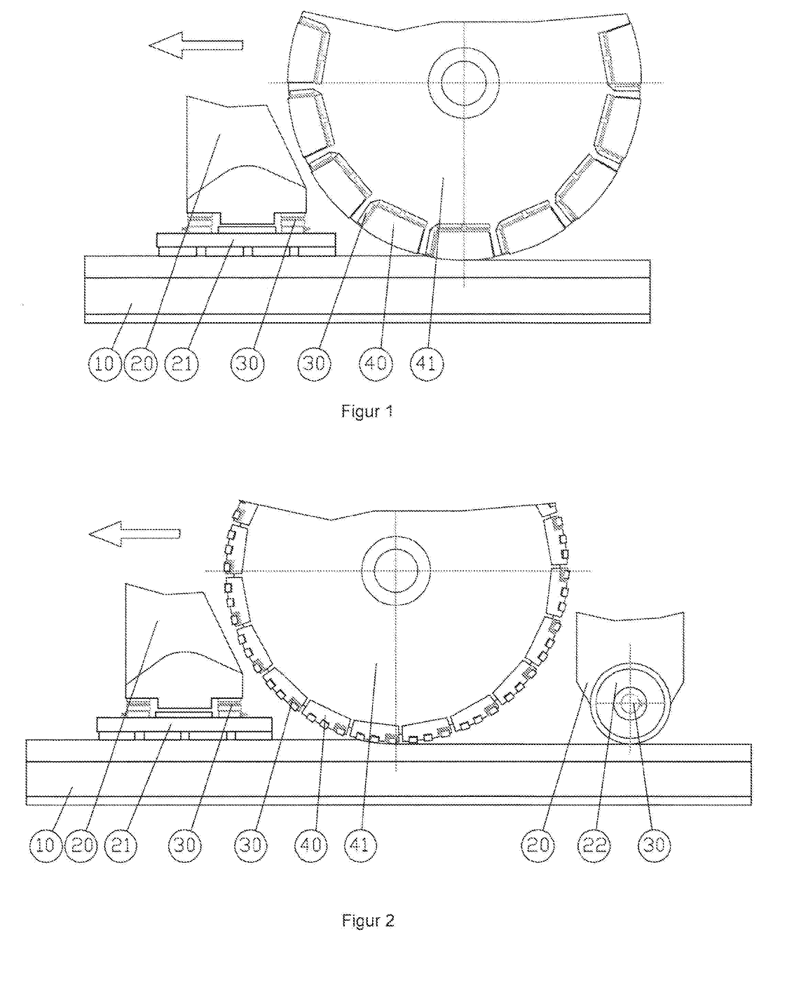

FIGS. 1 and 2 will be used for better explanation.

In the figures:

FIG. 1 shows a schematic arrangement of a contact pressure device having force measuring units having a machining tool arranged downstream in the travel direction, also having force measuring units, according to an embodiment according to the invention.

FIG. 2 shows a schematic arrangement of a machining tool having force measuring units, and one contact pressure device arranged upstream and downstream in each case, each having a force measuring unit according to an embodiment according to the invention.

### LIST OF REFERENCE NUMERALS

10 rail
20 contact pressure device
21 sliding element
22 contact pressure roller
30 force measuring unit
40 receptacle for machining tools
41 tool carrier

For better comprehensibility, several terms are explained hereafter and used in the following in each case with the generic term, which of course also includes the explained variants accordingly.

A contact pressure device (20) is used in machining rails for stabilizing the rail (10) during the maintenance travel and during the machining of the rail (10) by the machining tool. Such a contact pressure device (20) can be embodied as a roller or as a sliding element (21). Furthermore, at least one contact pressure device (20) can be associated with a machining tool. However, it is also possible to use only one contact pressure device (20) for multiple machining tools. In one embodiment variant, at least one contact pressure element is provided in front of the machining tool and at least one further one is provided after the machining tool viewed in the travel direction.

The adjustment to the rail (10), that is to say the application of the contact pressure force, can be performed hydraulically, pneumatically, or by an electric motor, with or without a mechanical transmission.

A machining tool can be a milling tool, a grinding tool, or a planing tool according to various embodiments known in the prior art. Since these embodiments are known to a person skilled in the art, the known embodiments without force measuring unit (30) will not be described in greater detail here.

The force measurement is performed by means of force measuring units (30), which ascertain the actually occurring force according to various physical principles.

The force measurement can be performed via sensors, which are based on the piezoelectric or the piezoresistive effect. Further possible sensors are known as strain gauges and operate on the basis of a varying resistance.

Furthermore, the deformations on elastic bodies can be determined via inductive, capacitive, or optical displacement transducers, and the existing force can thus be concluded. These applications are also known from other technical applications and a precise description of the different sensor structures will therefore be omitted here.

The data transfer to both a possible amplifier and also to the analysis unit and to the controller can be performed via conventional cables or also wirelessly. For example, technologies such as RFID or also Bluetooth or infrared are suitable for the wireless data transmission.

FIG. 1 schematically shows a contact pressure device (20) having a force measuring unit (30), which measures the actually occurring force, which the contact pressure device (20) exerts on the rail (10). The measurement and the knowledge about the actual force enable the active control of this variable and therefore substantially better control of the machining process.

Due to the measurement of the force in the immediate vicinity of the action, i.e., without significant friction and tension losses in the system, it can be used as an active control variable for contact pressure force during the rail machining.

In addition, due to the knowledge of the force and the known knowledge of the position, items of information are possible about the subsoil and the track structure as a whole and can be used for the control of the contact pressure force of the contact pressure device (20), or also for the control of the machining unit.

The adjusting force, the speed, the feed depth, and the advance can also be regulated as the most important parameters here in the machining device.

A further possibility, in addition to the force measurement on at least one contact pressure element, is the force measurement on the machining tool. In addition to the contact pressure force, the cutting force in particular, that is to say the force on the blade during the machining, can be measured here via force measuring units (30). In grinding tools, the force on the grinding means is determined here.

FIGS. 1 and 2 also illustrate an exemplary milling tool, in which the force measuring units are arranged at least at one cutting element, at one cutting element row, or one cutting cassette.

It is possible to equip each individual blade, or also a desired fraction of blades, with force measuring units (30). If the blades are partially equipped, a symmetrical angle division is advantageously selected, so that the force measuring elements are equally distributed around the circumference.

It is also possible to attach the force measuring units (30) at the interface between tool carrier (41) and spindle or in the mounting of the machining spindle and to measure the occurring forces here and therefore to supply them as information to the controller. The contact pressure device and/or the machining tool can in turn be controlled using the data of the cutting force.

In FIG. 2, one contact pressure element is arranged in front of and a further one is arranged after the machining tool. The arrangement of sliding element (21) or contact pressure roller (22) is only provided as an example here. Of course, two contact pressure rollers (22), two sliding elements (21), or an inverted arrangement can also be used here.

The system can be made more stable per se and the risk of oscillations is reduced once again by the use of two contact pressure elements.

In this case, the force measurement on the second contact pressure element can also be used simultaneously to the detection of the machined rail state. It is especially possible to thus determine surface roughness and in particular waviness.

By way of the information about the actually occurring forces in the contact pressure device (20) and/or the machining tool, it is possible to operate the process as a whole substantially more exactly and with lesser forces and therefore also reduced power consumption. Due to the lower forces, lesser wear on the components, in particular the contact pressure device (20), the rail (10), and also the machining tool is provided.

It is possible to actively integrate changed conditions of track substructure, variations in the rail material, and the like early into the controller and therefore to set the respective optimum conditions. The occurrence of possible oscillations can also be recognized early and an intervention can also be taken here.

Furthermore, rail machining according to the method according to the invention and/or the use of the device according to the invention can be automated more easily and the operator influence is substantially less.

It is therefore possible using the present invention to ensure an optimum force-dependent control of the contact pressure device (20) and/or a force-dependent control of the cutting force of the machining tool, and therefore optimum rail machining.

The method according to the invention and the device according to the invention are described in main claims 1 and 6, and also respectively in dependent claims 2-5 and 7-13.

1. A method for controlling at least one contact pressure device and at least one machining tool, comprising:
installing the at least one contact pressure device and the at least one machining tool on a rail vehicle;
using the at least one contact pressure device and the at least one machining tool for machining rails on a laid rail;
measuring at least one of: forces on the at least one contact pressure device and forces on the at least one machining device; and
using at least one of: the forces on the at least one contact pressure device and the forces on at least one machining device as a control variable for a rail machining operation.

2. The method according to claim 1, wherein the information of the measurement results is used for control of the force of the contact pressure device.

3. The method according to claim 1, wherein information of measurement results is used for control of the at least one machining device.

4. The method according to claim 1, wherein the at least one contact pressure device is arranged in a travel direction before or after the machining tool.

5. The method according to claim 1, wherein the at least one contact pressure device is arranged before the machining tool in a travel direction and at least one additional contact pressure device is arranged after the machining tool.

6. A device on a rail vehicle for machining rails on a laid rail, comprising:
a contact pressure device; and
a machining tool, wherein the occurring forces is measured on at least one of: the contact pressure device or the machining tool and a resulting signal thereof is used as a control variable for a rail machining operation.

7. The device according to claim 6, wherein the device is positioned on the contact pressure device.

8. The device according to claim 6, wherein the device is positioned on the machining tool.

9. The device according to claim 6, wherein forces are measured using a piezoelectric or piezoresistive force measuring unit.

10. The device according to claim 6, wherein forces are measured using strain gauges.

11. The device according to claim 6, wherein forces are measured using inductive, capacitive, or optical displacement transducers for ascertaining elastic deformations.

12. The device according to claim 6, wherein signal transmission is performed wirelessly.

13. The device according to claim 6, wherein a maximum distance between the device and the rail is 150 mm.

14. The method according to claim 3, wherein the control of the at least one machining device is control of one of: contact pressure force, speed, a feed depth, or an advance thereof.
